(19) United States
(12) Patent Application Publication
(10) Pub. No.: US 2026/0312290 A1
(43) Pub. Date: Oct. 8, 2026

(54) ANTENNA UNIT, ANTENNA ARRAY, AND COMMUNICATION DEVICE

(71) Applicants: Beijing BOE Sensor Technology Co., Ltd., Beijing (CN); BOE Technology Group Co., Ltd., Beijing (CN)

(72) Inventors: Wenxue MA, Beijing (CN); Yunnan JIN, Beijing (CN); Sihui BAO, Beijing (CN); Liang GUO, Beijing (CN)

(21) Appl. No.: 18/996,708

(22) PCT Filed: May 14, 2024
(86) PCT No.: PCT/CN2024/093229

§ 371 Date: Jan. 17, 2025

(30) Foreign Application Priority Data
Jun. 20, 2023 (CN) 202310731191.8

(51) Int. Cl. H01Q 9/04; H01Q 1/22; H01Q 1/38; H01Q 1/42

(52) U.S. Cl. CPC H01Q 9/0407; H01Q 1/22; H01Q 1/38; H01Q 1/42

(57) ABSTRACT

Disclosed in embodiments of the present disclosure are an antenna unit, an antenna array, and a communication device. A radiation patch is directly attached to the inner side of a radome, so that the radiation patch does not need to be supported by introducing a structure such as a fixing layer or a fixing buckle, the antenna structure is simpler, the overall profile height of the antenna can be effectively reduced, and the design concept of low profiles of existing antennas is met. In addition, a feed network is integrally formed by means of a sheet metal process, required lines can be directly and integrally processed, and other structures do not need to be additionally arranged at the suspended position for fixing.

### CROSS REFERENCE TO RELATED APPLICATION

This application is a national phase entry under 35 U.S.C § 371 of International Application No. PCT/CN2024/093229, filed on May 14, 2024, which claims priority to Chinese Patent Application No. 202310731191.8, filed with the China National Intellectual Property Administration on Jun. 20, 2023, and entitled “ANTENNA UNIT, ANTENNA ARRAY, AND COMMUNICATION DEVICE”, the entire contents of which are incorporated herein by reference.

### TECHNICAL FIELD

The present disclosure relates to the field of microwave communication technology, and in particular to an antenna unit, an antenna array, and a communication device.

### BACKGROUND

With the continuous development of mobile communication technology, antenna as an indispensable existence in communication devices. In addition to the requirements for higher electrical performance of antennas, people's aesthetic requirements for antennas as products are also increasing. Transparent antenna with its natural hidden characteristics can be better integrated into the environment, to achieve the beautification of communication equipment. In addition, antenna lightweight is also a major direction of the current development of mobile communications.

### SUMMARY

Embodiments of the present disclosure provide an antenna unit, an antenna array, and a communication device, which provides a lightweight and transparent antenna.

Embodiments of the present disclosure provide an antenna unit, including:
a substrate;
a radome, wherein the radome and the substrate form a cavity;
a radiating patch, wherein the radiating patch is provided within the cavity and is connected to a side of the radome facing the substrate;
at least one feed network, disposed within the cavity, wherein the feed network includes: a planar transmission line on a side of the substrate facing the radome, a coupling end disposed close to a side of the radiating patch and having a set gap with the radiating patch, and a longitudinal connection line connecting the planar transmission line and the coupling end; wherein the planar transmission line, the longitudinal connection line and the coupling end of the feed network are integrally molded using a sheet metal process, and the feed network is used for coupling feed to the radiating patch;
a metal grounding plate, provided on a side of the substrate facing away from the radiating patch.

Optionally, in the above antenna unit provided by the embodiments of the present disclosure, both the radiating patch and the metal grounding plate have a metal mesh-like structure.

Optionally, in the above antenna unit provided by the embodiments of the present disclosure, the radiating patch is fixedly connected to the radome by means of an optical adhesive, and the metal grounding plate is fixedly connected to the substrate by means of the optical adhesive.

Optionally, in the above antenna unit provided by the embodiments of the present disclosure, an orthographic projection of the radiating patch on the substrate covers orthographic projections of the coupling end and the longitudinal connection line on the substrate, as well as covers at least a part of an orthographic projection of the planar transmission line on the substrate.

Optionally, in the above antenna unit provided by the embodiments of the present disclosure, the antenna unit further includes a first feed network and a second feed network disposed independently of each other,
wherein the first feed network includes: a first planar transmission line on the side of the substrate facing the radome, a first coupling end disposed close to the side of the radiating patch and having a set gap with the radiating patch, and a first longitudinal connection line connecting the first planar transmission line and the first coupling end;
the second feed network includes: a second planar transmission line on the side of the substrate facing the radome, a second coupling end disposed close to the side of the radiating patch and having a set gap with the radiating patch, and a second longitudinal connection line connecting the second planar transmission line and the second coupling end;
wherein the first planar transmission line, the first longitudinal connection line and the first coupling end form a micro-strip line and are integrally molded using the sheet metal process, and the second planar transmission line, the second longitudinal connection line and the second coupling end form a micro-strip line and are integrally molded using the sheet metal process.

Optionally, in the above antenna unit provided by the embodiments of the present disclosure, orthogonal projections of the first planar transmission line, the first longitudinal connection line and the first coupling end on the substrate are located on a first straight line, and orthogonal projections of the second planar transmission line, the second longitudinal connection line and the second coupling end on the substrate are located on a second straight line, and the first straight line and the second straight line are provided orthogonally.

Optionally, in the above antenna unit provided by the embodiments of the present disclosure, an orthographic projection of the first feed network on the substrate does not overlap an orthographic projection of the second feed network on the substrate, and a first end of the first planar transmission line away from the first longitudinal connection line is provided proximate to a second end of the second planar transmission line away from the second longitudinal connection line.

Optionally, in the above antenna unit provided by the embodiments of the present disclosure, the first feed network further includes a third planar transmission line on the substrate and connected to the first end, and the second feed network further includes a fourth planar transmission line on the substrate and connected to the second end; wherein
the third planar transmission line is connected to the first planar transmission line at an angle greater than or equal to 90° and less than or equal to 135°, and the fourth planar transmission line is connected to the second planar transmission line at an angle greater than or equal to 90° and less than or equal to 135°.

Optionally, in the above antenna unit provided by the embodiments of the present disclosure, the first feed network and the second feed network are mirror symmetrical about a center of the radiating patch.

Optionally, in the above antenna unit provided by the embodiments of the present disclosure, an orthographic projection of the first coupling end on the substrate overlaps with an orthographic projection of the second coupling end on the substrate, the first coupling end is provided below the second coupling end, the first coupling end is bent at the overlap towards a side close to the substrate, and the second coupling end is bent at the overlap towards a side away from the substrate.

Optionally, in the above antenna unit provided by the embodiments of the present disclosure, a sum of lengths of the first planar transmission line, the first longitudinal connection line, and the first coupling end is a quarter wavelength of an operating frequency of the antenna unit, and a sum of lengths of the second planar transmission line, the second longitudinal connection line, and the second coupling end is a quarter wavelength of the operating frequency of the antenna unit.

Optionally, in the above antenna unit provided by the embodiments of the present disclosure, the antenna unit further includes a first feed network and a second feed network disposed independently of each other;
wherein the first feed network includes: a first input port on the side of the substrate facing the radome, a fifth planar transmission line and a sixth planar transmission line provided on the side of the substrate facing the radome and connected to the first input port, a first differential coupling end and a second differential coupling end provided close to a side of the radiating patch and having a set gap with the radiating patch, a third longitudinal connection line connecting the fifth planar transmission line and the first differential coupling end, and a fourth longitudinal connection line connecting the sixth planar transmission line and the second differential coupling end;
the second feed network includes: a second input port on the side of the substrate facing the radome, a seventh planar transmission line and an eighth planar transmission line provided on the side of the substrate facing the radome and connected to the second input port, a third differential coupling end and a fourth differential coupling end provided close to the side of the radiating patch and having a set gap with the radiating patch, a fifth longitudinal connection line connecting the seventh planar transmission line and the third differential coupling end, and a sixth longitudinal connection line connecting the eighth planar transmission line and the fourth differential coupling end;
wherein the first input port, the fifth planar transmission line, the sixth planar transmission line, the third longitudinal connection line, the fourth longitudinal connection line, the first differential coupling end and the second differential coupling end form a differential structure and are integrally molded by the sheet metal process, and the second input port, the seventh planar transmission line, the eighth planar transmission line, and the fifth longitudinal connection line, the sixth longitudinal connection line, the third differential coupling end and the fourth differential coupling end form a differential structure and are integrally molded using the sheet metal process.

Optionally, in the above antenna unit provided by the embodiments of the present disclosure, the first input port and the second input port are opposite to each other, and a connecting line of the first differential coupling end and the second differential coupling end is provided orthogonal to a connecting line of the third differential coupling end and the fourth differential coupling end;
the radiating patch is divided into four regions along a symmetry axis of the radiating patch, and the first differential coupling end, the second differential coupling end, the third differential coupling end and the fourth differential coupling end are provided in one-to-one correspondence with the regions.

Optionally, in the above antenna unit provided by the embodiments of the present disclosure, a difference between a length of the fifth planar transmission line and a length of the sixth planar transmission line is one-half the wavelength of the operating frequency of the antenna unit, and a difference between a length of the seventh planar transmission line and a length of the eighth planar transmission line is one-half the wavelength of the operating frequency of the antenna unit.

Optionally, in the above antenna unit provided by the embodiments of the present disclosure, the fifth planar transmission line, the sixth planar transmission line, the seventh planar transmission line and the eighth planar transmission line each are folded lines.

Optionally, in the above antenna unit provided by the embodiments of the present disclosure, an orthographic projection of the first feed network on the substrate does not overlap an orthographic projection of the second feed network on the substrate.

Optionally, in the above antenna unit provided by the embodiments of the present disclosure, the fifth planar transmission line and the sixth planar transmission line form a semi-enclosed structure, a portion of the seventh planar transmission line extends into the semi-enclosed structure through a notch in the semi-enclosed structure, and the eighth planar transmission line is located outside of the semi-enclosed structure.

Optionally, in the above antenna unit provided by the embodiments of the present disclosure, shapes of the first differential coupling end, the second differential coupling end, the third differential coupling end and the fourth differential coupling end include an “L” shape,
one ends of long sides of the “L” shapes away from short sides are connected to the third longitudinal connection line, the fourth longitudinal connection line, the fifth longitudinal connection line, and the sixth longitudinal connection line, respectively, in one-to-one correspondence, and the short sides of the “L” shapes are disposed close to a center of the radiating patch.

Optionally, in the above antenna unit provided by the embodiments of the present disclosure, the long side and the short side in the “L” shape are provided parallel to the radiating patch; or, the long side in the “L” shape is provided parallel to the radiating patch, and the short side in the “L” shape is bent along one end of the long side away from the radiating patch.

Optionally, in the above antenna unit provided by the embodiments of the present disclosure, the long side of the “L” shape at the first differential coupling end and the long side of the “L” shape at the second differential coupling end are disposed in a third straight line,
the long side of the “L” shape at the third differential coupling end and the long side of the “L” shape at the fourth differential coupling end are disposed in a fourth straight line, the third straight line and the fourth straight line are provided orthogonal.

Optionally, in the above antenna unit provided by the embodiments of the present disclosure, the first differential coupling end, the second differential coupling end, the third differential coupling end, and the fourth differential coupling end are mirror symmetrical about a center of the radiating patch.

Optionally, in the above antenna unit provided by the embodiments of the present disclosure, a ratio of a size of the radiating patch to a wavelength of an operating frequency of the antenna unit is 0.44 to 0.48.

Optionally, in the above antenna unit provided by the embodiments of the present disclosure, a shape of the radiating patch includes a square, a tangent square, a circle or a tangent polygon.

Optionally, in the above antenna unit provided by the embodiments of the present disclosure, a shape of the radiating patch includes four circles or rhombuses integrally formed and centrally symmetrical; or, a shape of the radiating patch includes four hexagonal shapes independently disposed and centrally symmetrical.

Optionally, in the above antenna unit provided by the embodiments of the present disclosure, a material of the substrate includes PC, COP, PET, PMMA or glass, and a material of the radome includes PC, COP, PET or PMMA.

Correspondingly, the embodiments of the present disclosure further provide an antenna array, including a plurality of antenna units provided by the embodiments of the present disclosure.

Optionally, in the above antenna array provided by the embodiments of the present disclosure, feed networks of the plurality of the antenna units are integrally molded using the sheet metal process.

Correspondingly, the embodiments of the present disclosure further provide a communication device, including the antenna array provided by the embodiments of the present disclosure.

The beneficial effects of the embodiments of the present disclosure are as follows.

The embodiments of the present disclosure provide an antenna unit, an antenna array, and a communication device, by directly affixing the radiating patch to an inner side of the radome, so that there is no need to introduce a structure such as a fixed layer or a fixed snap to support the radiating patch, the antenna structure is simpler, and the overall profile height of the antenna can be effectively reduced in line with the existing antenna low-profile design concept. In addition, the feed network is integrally molded through the sheet metal process, and the required line can be directly and integrally processed and overhanging place does not need additional other structures to do fixed, assembly is more simple, not only strengthen the strength and consistency of the antenna, but also solved the problem of assembly cost and difficulty, which is more conducive to automated assembly and production of the antenna, and greatly reduces the antenna assembly of labor input.

### BRIEF DESCRIPTION OF FIGURES

In order to more clearly illustrate the technical solutions in the embodiments of the present disclosure, the accompanying drawings to be used in the description of the embodiments will be briefly described below, and it will be obvious that the accompanying drawings in the following description are only some of the embodiments of the present disclosure, and that other accompanying drawings can be obtained based on these drawings for a person of ordinary skill in the art, without putting in creative labor.

FIG. 1 shows a three-dimensional schematic diagram of an antenna unit provided by embodiments of the present disclosure.

FIG. 2 shows a front view structure corresponding to FIG. 1.

FIG. 3 shows a top view structure corresponding to FIG. 1.

FIG. 4 shows a three-dimensional schematic diagram of yet another antenna unit provided by embodiments of the present disclosure.

FIG. 5 shows a front view structure corresponding to FIG. 4.

FIG. 6 shows a top view structure corresponding to FIG. 4.

FIG. 7 shows a three-dimensional enlarged schematic diagram of a first feed network and a second feed network in FIG. 1.

FIG. 8 shows a three-dimensional enlarged schematic diagram of yet another first feed network and second feed network provided by embodiments of the present disclosure.

FIG. 9 shows a top view structure of a first feed network in FIG. 4.

FIG. 10 shows a three-dimensional enlarged schematic diagram of a first feed network in FIG. 4.

FIG. 11 shows a top view structure of a second feed network in FIG. 4.

FIG. 12 shows a three-dimensional enlarged schematic diagram of a second feed network in FIG. 4.

FIG. 13 shows a plan view schematic diagram of a radiating patch provided by embodiments of the present disclosure.

FIG. 14 shows a plan view schematic diagram of yet another radiating patch provided by embodiments of the present disclosure.

FIG. 15 shows a plan view schematic diagram of yet another radiating patch provided by embodiments of the present disclosure.

FIG. 16 shows a plan view schematic diagram of yet another radiating patch provided by embodiments of the present disclosure.

FIG. 17 shows a plan view schematic diagram of yet another radiating patch provided by embodiments of the present disclosure.

FIG. 18 shows a plan view schematic diagram of yet another radiating patch provided by embodiments of the present disclosure.

FIG. 19 shows a plan view schematic diagram of yet another radiating patch provided by embodiments of the present disclosure.

FIG. 20 shows a plan view schematic diagram of yet another radiating patch provided by embodiments of the present disclosure.

FIG. 21 shows a schematic diagram of simulation results of a standing wave ratio corresponding to the antenna unit shown in FIG. 1.

FIG. 22 shows a schematic diagram of simulation results of a coupling degree corresponding to the antenna unit shown in FIG. 1.

FIG. 23 shows a schematic diagram of simulation results of a standing wave ratio corresponding to the antenna unit shown in FIG. 4.

FIG. 24 shows a schematic diagram of simulation results of a coupling degree corresponding to the antenna unit shown in FIG. 4.

FIG. 25 shows a schematic diagram of simulation results of an antenna gain corresponding to the antenna unit shown in FIG. 4.

FIG. 26 shows a schematic diagram of simulation results of a cross-polarization ratio corresponding to the antenna unit shown in FIG. 4.

FIG. 27 shows a schematic diagram of a small base station antenna array formed by the antenna unit shown in FIG. 1.

FIG. 28 shows a schematic diagram of a small base station antenna array formed by the antenna unit shown in FIG. 4.

FIG. 29 shows a three-dimensional schematic diagram of a first feed network and a second feed network in FIG. 27.

FIG. 30 shows a plan view schematic diagram of a first feed network and a second feed network in FIG. 28.

### DETAILED DESCRIPTION

In order to make the objects, technical solutions and advantages of the embodiments of the present disclosure clearer, the technical solutions of the embodiments of the present disclosure will be described clearly and completely in the following in conjunction with the accompanying drawings of the embodiments of the present disclosure. Obviously, the described embodiments are a part of the embodiments of the present disclosure, and not all of the embodiments. And the embodiments and the features in the embodiments of the present disclosure can be combined with each other without conflict. Based on the described embodiments of the present disclosure, all other embodiments obtained by a person of ordinary skill in the art without the need for creative labor are within the scope of protection of the present disclosure.

Unless otherwise defined, technical or scientific terms used in the present disclosure shall have the ordinary meaning understood by a person of ordinary skill in the field to which the present disclosure belongs. The terms “first”, “second”, and the like as used in the present disclosure do not indicate any order, number, or significance, but are only used to distinguish different components. The words “including” or “comprising” and the like are intended to mean that the component or object preceded by the word encompasses the components or objects listed after the word and their equivalents, and does not exclude other components or objects. Words such as “connected” or “coupled” are not limited to physical or mechanical connections, but may include electrical connections, whether direct or indirect.

It should be noted that the sizes and shapes of the figures in the accompanying drawings do not reflect true proportions, but are intended to be illustrative of the present disclosure. And throughout the same or similar labeling denotes the same or similar elements or elements having the same or similar function.

Antennas have an irreplaceable role in the field of wireless communication as a conversion device between guided waves and free-space transmission waves. However, with the development of science and economy, people's living standards are increasingly improved, electromagnetic radiation problems have begun to be more and more people's attention, and cases of small base station antennas in the cell building being destroyed by human beings have occurred from time to time. People want better signal coverage, but they don't want radiation. Transparent with its natural concealment characteristics can be better integrated into the environment, to achieve the beautification of communication equipment. In addition, the concealability of transparent antennas can effectively reduce people's concerns about electromagnetic radiation. Moreover, antenna lightweight is also a major direction of the current development of mobile communications.

In the related art, the base station antenna feeding method mainly has the following two manners: the first manner is to use the direct feeding method, that is, using the metal grid process to directly and integrally process the feed network and radiating patch; and the second manner is to use the coupling method, for example, the metal grid micro-strip line is etched in the PCB board, but this process needs to be fixed by adding a column. The first manner cannot avoid a lot of welding points and the metal grid itself cannot be welded, there is a big problem; similarly to the first manner, in the second manner, whether it is a metal grid micro-strip line or a conventional micro-strip line (solid copper), the line needs to be introduced for fixing the structure of coupling wire portion, the design is difficult and the cost of processing is relatively large.

Therefore, the development of a lightweight and transparent antenna of the base station is necessary for those skilled in the art.

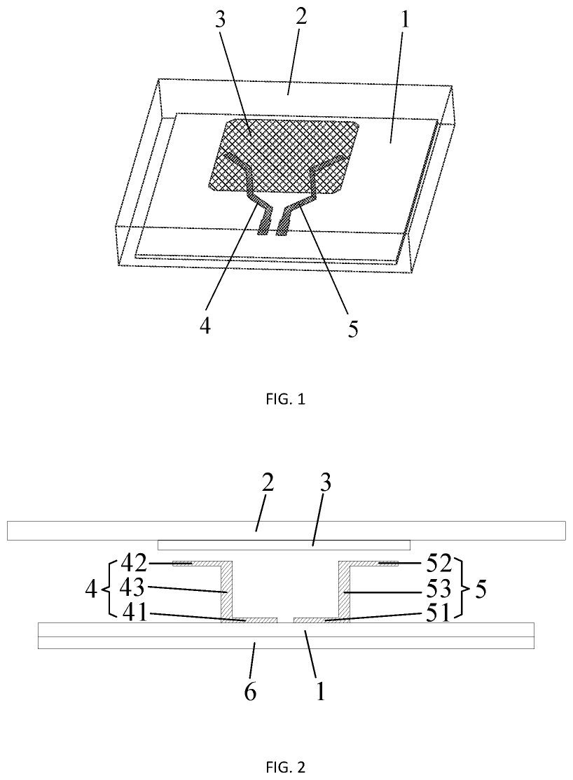

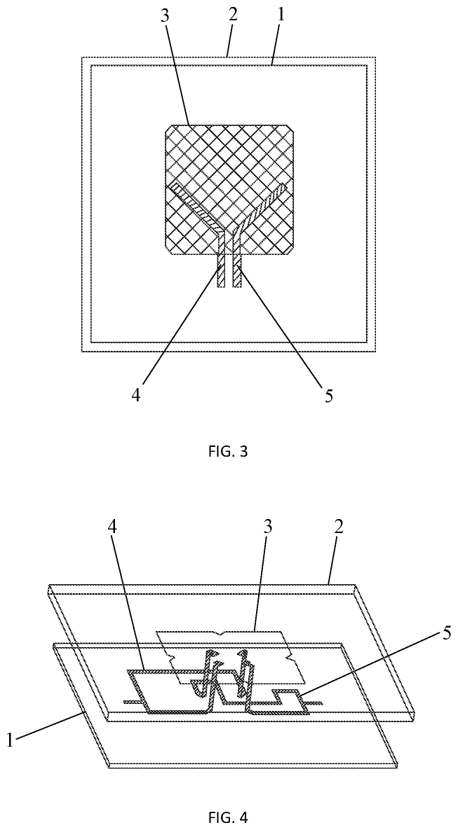

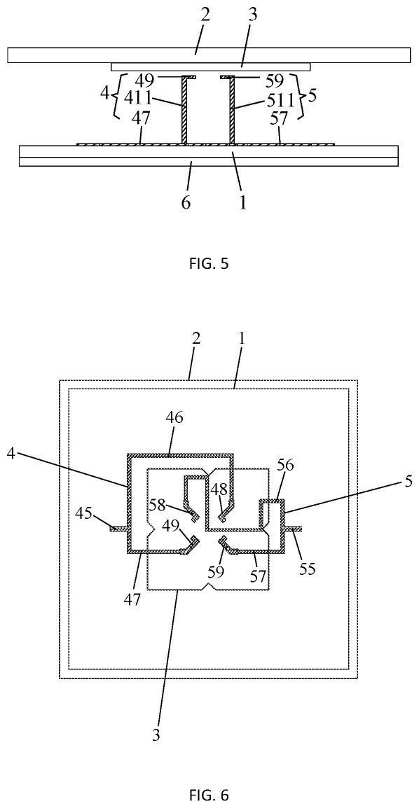

Embodiments of the present disclosure provide an antenna unit, as shown in FIG. 1 to FIG. 6, FIGS. 1 and 4 show three-dimensional schematic diagrams of two antenna units provided by embodiments of the present disclosure, FIG. 2 shows a front view structure corresponding to FIG. 1, FIG. 3 shows a top view structure corresponding to FIG. 1, FIG. 5 shows a front view structure corresponding to FIG. 4, FIG. 6 shows a top view structure corresponding to FIG. 4. The antenna unit includes:
a substrate 1;
a radome 2, where the radome 2 and the substrate 1 form a cavity; the radome 2 is used to protect an internal structure of the antenna unit;
a radiating patch 3, provided in the cavity, wherein the radiating patch 3 is connected to a side of the radome 2 facing the substrate 1; such that the radiating patch 3 is attached to an inner side of the radome 2 and is provided opposite to the substrate 1;
at least one feed network (in the case of two, 4 and 5, respectively), where the feed networks (4 and 5) are provided in the cavity, the feed networks (4 and 5) each includes: a planar transmission line on the side of the substrate 1 facing the radome 2, a coupling end provided close to the side of the radiating patch 3 and having a set gap with the radiating patch 3, and a longitudinal connection line connecting the planar transmission line and the coupling end; where the planar transmission line, the longitudinal connection line and the coupling end the feed networks (4 and 5) are integrally molded using a sheet metal process, and the feed networks (4 and 5) are used for coupling feed to the radiating patch 3;
a metal grounding plate 6, provided on the side of the substrate 1 facing away from the radiating patch 3.

In the above antenna unit provided by the embodiments of the present disclosure, by directly affixing the radiating patch to an inner side of the radome, so that there is no need to introduce a structure such as a fixed layer or a fixed snap to support the radiating patch, the antenna structure is simpler, and the overall profile height of the antenna can be effectively reduced in line with the existing antenna low-profile design concept. In addition, the feed network is integrally molded through the sheet metal process, and the required line can be directly and integrally processed and overhanging place does not need additional other structures to do fixed, assembly is more simple, compared to traditional balun or PCB power divider structures, not only strengthen the strength and consistency of the antenna, but also solved the problem of assembly cost and difficulty, which is more conducive to automated assembly and production of the antenna, and greatly reduces the antenna assembly of labor input.

Optionally, the radome 2 can be connected to the upper surface of the substrate 1, or, the radome 2 can be connected to the side surface of the substrate 1, to realize the formation of a cavity that accommodates the internal structure of the antenna unit.

Optionally, the sheet metal process can include at least one of folding, splicing and molding.

Specifically, as shown in FIG. 1 to FIG. 6, the metal grounding plate 6 is equivalent to a reflective plate for reflecting an antenna rearward beam to improve a forward gain and front-to-back ratio of the antenna.

Specifically, as shown in FIG. 1 to FIG. 6, the feed network (4 and 5) is used to transmit the energy generated by the transmitter to the radiating patch 3, and the radiating patch 3 is used to receive the signals output from the feed network (4 and 5) and to radiate the electromagnetic wave signals; the radiating patch 3 and the feed network (4 and 5) are coupled with each other using the air as the medium, and the feed network (4 and 5) directly transmits the electromagnetic wave, and conversely the electromagnetic wave received by the radiating patch (4 and 5) can also be transmitted to the receiver through the feed network (4 and 5); in this way, the antenna unit provided by the embodiments of the present disclosure adopts a dual-polarization feed network (4 and 5), which can ensure that the antenna unit can receive electromagnetic waves from space while radiating signals to space, so that the antenna size can be compressed and a transceiver duplex mode can be realized under a small size.

In specific implementations, in the above antenna unit provided in embodiments of the present disclosure, as shown in FIG. 1 to FIG. 6, the metal grounding plate 6 is fixedly connected to the substrate 1 via an optical adhesive, i.e., the substrate 1 is used to fix the metal grounding plate 6 on its lower surface and the feed network (4 and 5) on its upper surface; the radiating patch 3 can be fixedly connected to the radome 2 via an optical adhesive (OCA), so that there is no need to introduce a fixing layer or a fixing snap or the like to support the radiating patch, the antenna structure is simpler, the antenna stability is good, and the overall profile height of the antenna can be effectively reduced to realize the lightweight and low-profile characteristics of the antenna.

In specific implementations, in the above antenna unit provided in the embodiments of the present disclosure, as shown in FIG. 1 to FIG. 6, the feed network (4 and 5) and the substrate 1 can be fixed by plastic screws.

In particular embodiments, in the above antenna unit provided by embodiments of the present disclosure, as shown in FIG. 1 to FIG. 6, the radiating patch 3 and the metal grounding plate 6 both have a metal mesh-like structure. In this way, the radiating patch 3 and the metal grounding plate 6 both have high light transmittance, so that the antenna unit has certain transparent characteristics, and the concealability of the transparent antenna can not only realize the beautification of the communication equipment, but also effectively attenuate people's concern about electromagnetic radiation.

It should be noted that the metal grounding plate adopts a metal grid architecture, which does not affect its normal function, but can ensure a high transparency characteristic.

Optionally, the radiating patch 3 and the metal grounding plate 6 can be obtained by utilizing a metal grid embossing or etching process, which is certainly not limited to this.

In specific implementations, in order to realize antenna transparency, in the above antenna unit provided by embodiments of the present disclosure, as shown in FIG. 1 to FIG. 6, the substrate 1 can be a transparent substrate, and the material of the substrate 1 can include, but is not limited to, all transparent rigid substrates, such as PC (Polycarbonate), COP (Copolymers of Cycloolefin), PET (Polyethylene Terephthalate), PMMA (Polymethl Methacrylate), and glass etc., and the glass can include, but is not limited to, transparent low loss glass.

Optionally, the thickness of the substrate 1 ranges from 1 mm to 3 mm, for example, the thickness of the substrate 1 can be 1 mm, 2 mm, 3 mm, etc., and the thickness of the substrate 1 is selected according to the actual need.

In specific implementations, in order to realize antenna transparency, in the above antenna unit provided by embodiments of the present disclosure, as shown in FIG. 1 to FIG. 6, the material of the radome 2 includes but is not limited to PC, COP, PET or PMMA.

Optionally, the thickness of the radome 2 ranges from 1 mm to 3 mm, for example, the thickness of the radome 2 can be 1 mm, 2 mm, 3 mm, etc., and the thickness of the radome 2 is selected according to the actual need.

In the above antenna unit provided by the embodiments of the present disclosure, in addition to the feed network formed by the integrated processing of sheet metal technology, the remaining structures (substrate, radome, radiating patch, and metal grounding plate) are all of high transparency design, which not only ensures that the antenna itself has the characteristics of aesthetics and high concealment, but also solves a series of problems (such as cost, design difficulty, etc.) brought about by the feeder routing in the conventional design scheme. Compared to the antenna in the related art, the antenna design proposed in the embodiments of the present disclosure, the feed network is integrally molded through the sheet metal process, which can directly and integrally process the required lines and the overhangs do not need to add other structures to do the fixing, the assembly is more simple, compared to the traditional baron or PCB power dividion structure, not only to strengthen the antenna's strength and consistency, but also solve the problem of the assembly cost and difficulty, which is more conducive to the automated assembly and production of the antenna, and greatly reduces the antenna assembly labor input. Therefore, the design of the antenna unit provided by the embodiments of the present disclosure has the advantages of simple structure, lower processing cost, good stability, aesthetics, and good concealment.

Optionally, the feed network can be made of metal materials such as aluminum, copper, and the like.

Optionally, the thickness of the feed network can range from 0.6 mm to 1 mm, for example, the thickness of the feed network can be 0.6 mm, 0.7 mm, 0.8 mm, 0.9 mm, 1 mm, etc., and the thickness of the feed network can be selected according to the actual need.

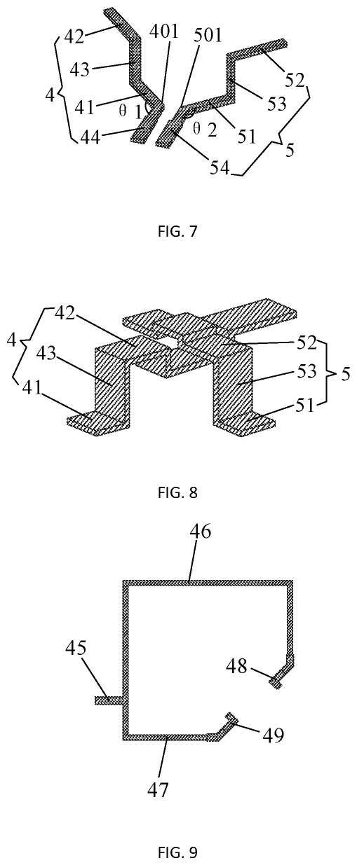

In specific implementations, in the above antenna unit provided in the embodiments of the present disclosure, as shown in FIG. 1 to FIG. 3, the antenna unit includes a first feed network 4 and a second feed network 5 independently of each other. FIG. 7 shows a three-dimensional enlarged schematic diagram of the first feed network 4 and the second feed network 5 in FIG. 1. The first feed network 4 includes: a first planar transmission line 41 disposed on the side of the substrate 1 facing the radome 2, a first coupling end 42 disposed close to the side of the radiating patch 3 and having a set gap with the radiating patch 3, and a first longitudinal connection line 43 connecting the first planar transmission line 41 and the first coupling end 42. The second feed network 5 includes: a second planar transmission line 51 on the side of the substrate 1 facing the radome 2, a second coupling end 52 disposed close to the side of the radiating patch 3 and having a set gap with the radiating patch 3, and a second longitudinal connection line 53 connecting the second planar transmission line 51 and the second coupling end 52. The first planar transmission line 41, the first longitudinal connection line 43, and the first coupling end 42 form a micro-strip line and are integrally molded using the sheet metal process. The second planar transmission line 51, the second longitudinal connection line 53, and the second coupling end 52 form a micro-strip line and are integrally molded using the sheet metal process. In this way, there is a set gap between the first coupling end 42 and the radiating patch 3 to realize the coupling feed, and there is a set gap between the second coupling end 52 and the radiating patch 3 to realize the coupling feed. Among them, the first planar transmission line 41, the first longitudinal connection line 43 and the first coupling end 42, and the second planar transmission line 51, the second longitudinal connection line 53 and the second coupling end 52 are formed by the sheet metal process, and are formed by at least one of folding, splicing and molding, which makes the fabrication process simpler, and at the same time reduces the cost.

In specific implementations, in the above antenna unit provided in the embodiments of the present disclosure, as shown in FIG. 1 to FIG. 3 and FIG. 7, orthographic projections of the first planar transmission line 41, the first longitudinal connection line 43, and the first coupling end 42 on the substrate 1 are located in a first straight line, i.e., the orthographic projections of the first planar transmission line 41, the first longitudinal connection line 43, and the first coupling end 42 on the substrate 1 are located in the same straight line; and orthographic projections of the second planar transmission line 51, the second longitudinal connection line 53 and the second coupling end 52 on the substrate 1 are located on a second straight line, i.e., the orthographic projections of the second planar transmission line 51, the second longitudinal connection line 53 and the second coupling end 52 on the substrate 1 are located on the same straight line. The first straight line and the second straight line are provided orthogonally.

In specific implementations, in the above antenna unit provided in the embodiments of the present disclosure, as shown in FIG. 1 to FIG. 3 and FIG. 7, the orthographic projections of the first feed network 4 and the second feed network 5 on the substrate 1 do not overlap with each other, and a first end 401 of the first planar transmission line 41 away from the first longitudinal connection line 43 is provided proximate to a second end 501 of the second planar transmission line 51 away from the second longitudinal connection line 53.

In specific implementations, in the above antenna unit provided in the embodiment of the present disclosure, as shown in FIG. 1 to FIG. 3 and FIG. 7, the first feed network 4 further includes a third planar transmission line 44 disposed on the substrate 1 and connected to the first end 401; and the second feed network 5 further includes a fourth planar transmission line 54 disposed on the substrate 1 and connected to the second end 501; wherein
the third planar transmission line 44 is connected to the first planar transmission line 41 at an angle θ1 greater than or equal to 90° and less than or equal to 135°, and the fourth planar transmission line 54 is connected to the second planar transmission line 51 at an angle θ2 greater than or equal to 90° and less than or equal to 135°.

Optionally, in the embodiments of the present disclosure, for example, the angle θ1 at the connection between the third planar transmission line 44 and the first planar transmission line 41 is 135°, and the angle θ2 at the connection between the fourth planar transmission line 54 and the second planar transmission line 51 is 135°, so that ±45° bipolarization coupling feed can be realized for the radiating patch 3.

Specifically, a width of a portion of the third planar transmission line 44 away from the first planar transmission line 41 is greater than a width of the first planar transmission line 41, to realize impedance matching of the various portions of the feed network in the antenna unit, and a width of a portion of the fourth planar transmission line 54 away from the second planar transmission line 51 is greater than a width of the second planar transmission line 51, to realize impedance matching of the various portions of the feed network in the antenna unit.

In specific implementations, in the above antenna unit provided by embodiments of the present disclosure, as shown in FIG. 1 to FIG. 3 and FIG. 7, the first feed network 4 and the second feed network 5 are mirror symmetrical about the center of the radiating patch 3.

In particular embodiments, in the above antenna unit provided by the embodiments of the present disclosure, as shown in FIG. 1 to FIG. 3, the orthographic projection of the radiating patch 3 on the substrate 1 covers the orthographic projections of the coupling ends (42 and 52) and the longitudinal connection lines (43 and 53) on the substrate 1 as well as covers at least a part of the orthographic projections of the planar transmission lines (41 and 51) on the substrate 1. This enables the coupling ends (42 and 52) to feed the radiating patch 3.

The first feed network 4 and the second feed network 5 of the micro-strip line structure shown in FIG. 1 to FIG. 3 provided by the embodiments of the present disclosure adopt a mirror-symmetrical L-shaped structure, and a sum of the lengths of the first planar transmission line 41, the first longitudinal connection line 43, and the first coupling end 42 is designed to be a quarter wavelength of an operating frequency of the antenna unit, and a sum of the lengths of the second planar transmission line 51, the second longitudinal connection line 53, and the second coupling end 52 is designed to be a quarter wavelength of an operating frequency of the antenna unit, impedance matching of various portions of the feed network in the antenna unit can be realized, and ±45° dual-polarization coupling feed can be realized for the radiating patch 3 by inputting AC signals to the third planar transmission line 44 and the fourth planar transmission line 54.

In specific implementations, in the above antenna unit provided in the embodiments of the present disclosure, the first feed network 4 and the second feed network in FIG. 1 to FIG. 3 can also be replaced with the structure shown in FIG. 8. As shown in FIG. 8, orthographic projections of the first coupling end 42 and the second coupling end 52 on the substrate 1 overlap with each other, the first coupling end 42 can be provided below the second coupling end 52, and the first coupling end 42 is bent at the overlap towards a side close to the substrate 1, and the second coupling end 52 is bent to the side away from the substrate 1 at the overlap; and, orthographic projections of the first planar transmission line 41, the first longitudinal connection line 43, and the first coupling end 42 on the substrate 1 are disposed in a first straight line, and orthographic projections of the second planar transmission line 51, the second longitudinal connection line 53, and the second coupling end 52 on the substrate 1 are disposed in a second straight line, and the first straight line and the second straight line are provided orthogonally. In this way, the first feed network 4 and the second feed network 5 are designed in an intersecting form, and by designing a sum of the lengths of the first planar transmission line 41, the first longitudinal connection line 43 and the first coupling end 42 to be a quarter wavelength of an operating frequency of the antenna unit, and by designing a sum of the lengths of the second planar transmission line 51, the second longitudinal connection line 53 and the second coupling end 52 to be a quarter wavelength of an operating frequency of the antenna unit, impedance matching of various portions of the feed network in the antenna unit can be realized, and ±45° dual-polarization coupled feed can be realized for the radiating patch 3 by inputting AC signals to the third planar transmission line 44 and the fourth planar transmission line 54.

It should be noted that the first feed network 4 and the second feed network 5 shown in FIG. 1 to FIG. 3 and FIG. 8 are only a structure provided by the embodiments of the present disclosure, and in the specific implementations, the first feed network 4 and the second feed network 5 are not limited to the structure shown in FIG. 1 to FIG. 3 and FIG. 8, and as long as they are capable of realizing the micro-strip line coupled power feed, they all fall within the scope of protection of the embodiments of the present disclosure.

In specific implementations, in the above antenna unit provided in the embodiments of the present disclosure, as shown in FIG. 4 to FIG. 6, the antenna unit includes a first feed network 4 and a second feed network 5 independently disposed of each other.

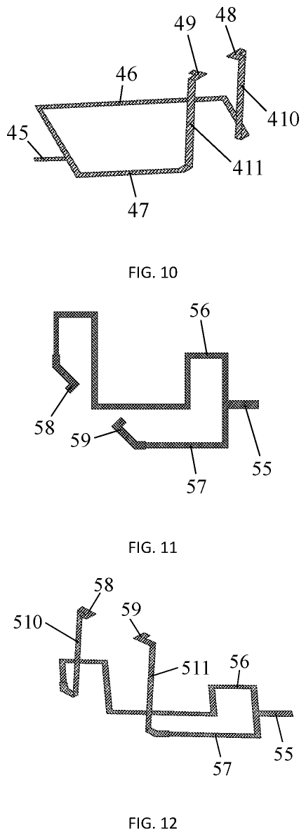

As shown in FIG. 9 to FIG. 12, FIG. 9 shows a top view structure of the +45°-polarized first feed network 4 in FIG. 4, FIG. 10 shows a three-dimensional enlarged schematic diagram of the +45°-polarized first feed network 4 in FIG. 4, FIG. 11 shows a top view structure of the −45°-polarized second feed network 5 in FIG. 4, and FIG. 12 shows a three-dimensional enlarged schematic diagram of the −45°-polarized second feed network 5 in FIG. 4. The first feed network 4 includes: a first input port 45 disposed on a side of the substrate 1 facing the radome 2, a fifth planar transmission line 46 and a sixth planar transmission line 47 disposed on the side of the substrate 1 facing the radome 2 and connected to the first input port 45, a first differential coupling end 48 and a second differential coupling end 49 disposed close to the side of the radiating patch 3 and having a set gap with the radiating patch 3, a third longitudinal connection line 410 connecting the fifth planar transmission line 46 and the first differential coupling end 48, and a fourth longitudinal connection line 411 connecting the sixth planar transmission line 47 and the second differential coupling end 49.

The second feed network 5 includes: a second input port 55 provided on the side of the substrate 1 facing the radome 2, a seventh planar transmission line 56 and an eighth planar transmission line 57 provided on the side of the substrate 1 facing the radome 2 and connected to the second input port 55, a third differential coupling end 58 and a fourth differential coupling end 59 provided close to the side of the radiating patch 3 and having a set gap with the radiating patch 3, a fifth longitudinal connection line 510 connecting the seventh planar transmission line 56 and the third differential coupling end 58, and a sixth longitudinal connection line 511 connecting the eighth planar transmission line 57 and the fourth differential coupling end 59.

Here, the first input port 45, the fifth planar transmission line 46, the sixth planar transmission line 47, the third longitudinal connection line 410, the fourth longitudinal connection line 411, the first differential coupling end 48, and the second differential coupling end 49 form a differential structure and are integrally molded using the sheet metal process; and the second input port 55, the seventh planar transmission line 56, the eighth planar transmission line 57, the fifth longitudinal connection line 510, the sixth longitudinal connection line 511, the third differential coupling end 58 and the fourth differential coupling end 59 form a differential structure and are integrally molded using the sheet metal process. In this way, the first feed network 4 and the second feed network 5 are formed by at least one of folding, splicing and molding, which makes the fabrication process simpler and also reduces the cost. In this way, a set gap exists between the first differential coupling end 48, the second differential coupling end 49 and the radiating patch 3 to realize the differential coupling feed, and a set gap exists between the third differential coupling end 58, the fourth differential coupling end 59 and the radiating patch 3 to realize the differential coupling feed.

In specific implementations, in the above antenna unit provided in the embodiments of the present disclosure, as shown in FIG. 4 to FIG. 6, the first input port 45 and the second input port 55 are provided opposite to each other, and a connecting line of the first differential coupling end 48 and the second differential coupling end 49 is provided orthogonally to a connecting line of the third differential coupling end 58 and the fourth differential coupling end 59.

The radiating patch 3 is divided into four regions along a symmetry axis of the radiating patch, and the first differential coupling end 48, the second differential coupling end 49, the third differential coupling end 58, and the fourth differential coupling end 59 are provided in one-to-one correspondence with the respective regions.

In specific implementations, in the above antenna unit provided in the embodiments of the present disclosure, as shown in FIG. 4 to FIG. 6, a difference between a length of the fifth planar transmission line 46 and a length of the sixth planar transmission line 47 is one-half the wavelength of the operating frequency of the antenna unit, and a difference between a length of the seventh planar transmission line 56 and a length of the eighth planar transmission line 57 is one-half the wavelength of the operating frequency of the antenna unit.

In specific implementations, in the above antenna unit provided in the embodiments of the present disclosure, as shown in FIG. 4 to FIG. 6, the fifth planar transmission line 46, the sixth planar transmission line 47, the seventh planar transmission line 56, and the eighth planar transmission line 57 each are folded lines, respectively. This allows the first differential coupling end 48, the second differential coupling end 49, the third differential coupling end 58 and the fourth differential coupling end 59 to be correspondingly fixed to the four regions of the radiating patch 3, thereby realizing differential coupling feed.

In specific implementations, in the above antenna unit provided in the embodiments of the present disclosure, as shown in FIG. 4 to FIG. 6, an orthographic projection of the first feed network 4 on the substrate 1 does not overlap an orthographic projection of the second feed network 5 on the substrate 1; the fifth planar transmission line 46 and the sixth planar transmission line 47 form a semi-enclosed structure, and a portion of the seventh planar transmission line 56 extends into the semi-enclosed structure through a notch of the semi-enclosed structure. The eighth planar transmission line 57 is located outside the semi-enclosed structure. This allows the first feed network 4 and the second feed network 5 to be independent of each other.

It should be noted that the first feed network 4 and the second feed network 5 shown in FIG. 4 to FIG. 6 are only a structure provided by the embodiments of the present disclosure. In specific implementations, the first feed network 4 and the second feed network 5 are not limited to the structure shown in FIG. 4 to FIG. 6, as long as they can realize differential coupled feeding, they are within the scope of protection of the embodiments of the present disclosure. For example, the orthographic projection of the first feed network 4 on the substrate 1 and the orthographic projection of the second feed network 5 on the substrate 1 can also be overlapped, and the first feed network 4 and the second feed network 5 need to be bent as in FIG. 8 to make the first feed network 4 and the second feed network 5 unconnected at the overlap.

In specific implementations, in the above antenna unit provided in the embodiments of the present disclosure, as shown in FIG. 4 to FIG. 6 and FIG. 9 to FIG. 12, the shapes of the first differential coupling end 48, the second differential coupling end 49, the third differential coupling end 58, and the fourth differential coupling end 59 can be of an “L” shape, and one ends of long sides of the “L” shapes away from short sides are connected to the third longitudinal connection line 410, the fourth longitudinal connection line 411, the fifth longitudinal connection line 510, and the sixth longitudinal connection line 511, respectively, in one-to-one correspondence, and the short sides of the “L” shapes are disposed close to a center of the radiating patch 3. By designing the “L”-shaped differential coupling ends, the coupling area can be increased and the electromagnetic wave radiation intensity can be improved.

In specific implementations, in the above antenna unit provided in embodiments of the present disclosure, as shown in FIG. 4 to FIG. 6 and FIG. 9 to FIG. 12, the long side and the short side in the “L” shape can be set parallel to the radiating patch 3, i.e., the long side and the short side in the “L” shape are on the same plane, which can further increase the coupling area of the first differential coupling end 48, the second differential coupling end 49, the third differential coupling end 58 and the fourth differential coupling end 59 with the radiating patch 3, thereby further improving the electromagnetic wave radiation intensity.

Of course, in specific implementations, in the above antenna unit provided in the embodiments of the present disclosure, as shown in FIG. 4 to FIG. 6 and FIG. 9 to FIG. 12, the long side in the “L” shape can be provided in parallel to the radiating patch 3, and the short side in the “L” shape can be bent along one end of the long side away from the radiating patch 3, for example, the short side can be perpendicular to the long side, and the end of the short side that is not connected to the long side is far away from the radiating patch 3, so that the coupling function of the electromagnetic wave can also be realized. Of course, in specific implementations, the shapes of the first differential coupling end 48, the second differential coupling end 49, the third differential coupling end 58, and the fourth differential coupling end 59 may also be other shapes, not limited to the “L” shape provided by the embodiments of the present disclosure, as long as the shape of the differential coupling end capable of realizing coupling of the electromagnetic wave to the radiating patch 3, they are protected by the embodiments of the present disclosure.

In specific implementations, in the above antenna unit provided in the embodiments of the present disclosure, as shown in FIG. 4 to FIG. 6 and FIG. 9 to FIG. 12, the long side of the “L” shape of the first differential coupling end 48 and the long side of the “L” shape of the second differential coupling end 49 are located in a third straight line, and the long side of the “L” shape of the third differential coupling end 58 and the long side of the “L” shape of the fourth differential coupling end 59 are located in a fourth straight line; the third straight line and the fourth straight line are provided orthogonally; the first differential coupling end 48, the second differential coupling end 49, the third differential coupling end 58, and the fourth differential coupling end 59 are mirror symmetrical about the center of the radiating patch 3. In this way, by designing a difference between a length of the fifth planar transmission line 46 and a length of the sixth planar transmission line 47 to be one-half of the wavelength of the operating frequency of the antenna unit, and designing a difference between a length of the seventh planar transmission line 56 and a length of the eighth planar transmission line 57 to be one-half of the wavelength of the operating frequency of the antenna unit, ±45° dual-polarization differential coupling feed can be realized for the radiating patch 3 by inputting signals to the first input port 45 and the second input port 55, the first differential coupling end 48 and the second differential coupling end 49 transmit signals with the same amplitude and 180° phase difference, the third differential coupling end 58 and the fourth differential coupling end 59 transmit signals with the same amplitude and 180° phase difference, and the feed network adopts differential alignments to feed the radiating patch 3, to achieve equal amplitude of the differential mode signals feeding on the radiating patch 3.

In specific implementations, in the above antenna unit provided in the embodiments of the present disclosure, as shown in FIG. 1 to FIG. 6, the size of the radiating patch 3 can be about one-half of the wavelength of the operating frequency of the antenna unit, for example, the ratio of the size of the radiating patch 3 to the wavelength of the operating frequency of the antenna unit ranges from 0.44 to 0.48. Specifically, when the shape of the radiating patch 3 is square, the size of the radiating patch 3 is the diagonal length. When the shape of the radiating patch 3 is circular, the size of the radiating patch 3 is the diameter.

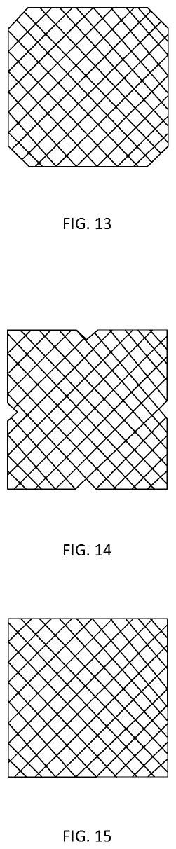

In specific implementations, in the above antenna unit provided in the embodiments of the present disclosure, as shown in FIG. 1 to FIG. 6, the shape of the radiating patch 3 can be a tangent square, and tangent corners can be at midpoints of the four sides of the square, or tangent corners can be at four corners of the square, and the sizes of the tangent corners are adjustable, so that the impedance matching and the polarization isolation of the antenna can be adjusted to improve the performance of the antenna by changing the size of the tangent corner. For example, the radiating patch 3 in FIG. 1 to FIG. 3 adopts a tangent square where the tangent corners are set at four corners of the square, as shown in FIG. 13; the radiating patch 3 in FIG. 4 to FIG. 6 adopts a tangent square where the tangent corners are set at the four sides of the square, as shown in FIG. 14; of course, the radiating patch 3 in FIG. 1 to FIG. 3 can also adopt the structure of the radiating patch 3 shown in FIG. 14, and the radiating patch 3 in FIG. 4 to FIG. 6 can also adopt the structure of the radiating patch 3 shown in FIG. 3.

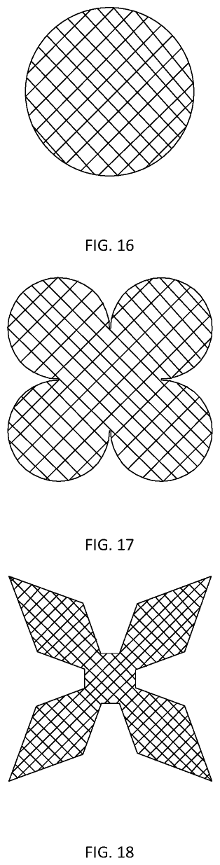

Optionally, the radiating patch 3 in FIG. 1 to FIG. 6 can also be replaced with the square shown in FIG. 15, and can also be replaced with the circle shown in FIG. 16; and of course, the radiating patch 3 in FIG. 1 to FIG. 6 can also be replaced with a tangent polygon, an ellipse, or even other irregular shapes.

Optionally, the radiating patch 3 in FIG. 4 to FIG. 6 can also be replaced with the shapes shown in FIGS. 17 and 18. As shown in FIG. 17, the shape of the radiating patch 3 includes four circles integrally molded and centrally symmetrical, such that the first differential coupling end 48, the second differential coupling end 49, the third differential coupling end 58, and the fourth differential coupling end 59 are provided in a one-to-one correspondence with the four circles, respectively. As shown in FIG. 18, the shape of the radiating patch 3 includes four rhombuses integrally molded and centrally symmetrical, such that the first differential coupling end 48, the second differential coupling end 49, the third differential coupling end 58, and the fourth differential coupling end 59 are provided in one-to-one correspondence with the four rhombuses, respectively.

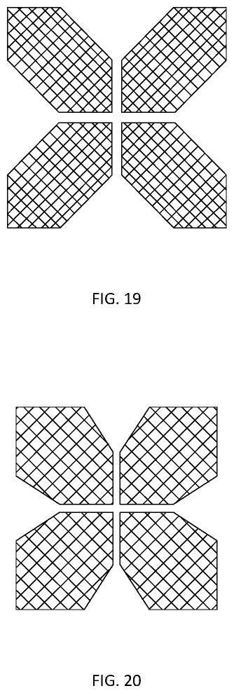

Optionally, the radiating patch 3 in FIG. 4 to FIG. 6 can also be replaced with the shapes shown in FIGS. 19 and 20. As shown in FIGS. 19 and 20, the shape of the radiating patch 3 includes four hexagons independently disposed and centrally symmetrical, i.e., a butterfly shaped structure of the radiating patch 3 is adopted, such that the first differential coupling end 48, the second differential coupling end 49, the third differential coupling end 58 and the fourth differential coupling end 59 are disposed in one-to-one correspondence with the four hexagons respectively.

Optionally, the shape of the radiating patch 3 corresponding to the feed network shown in FIG. 8 can be any of the structures in FIG. 13 to FIG. 20.

It should be noted that the grid lines in the metal grid-like structure of the radiating patch 3 shown in FIG. 13 to FIG. 20 are all diagonal lines, and of course the grid lines can be crossed horizontally and vertically.

It should be noted that the feed network in embodiments of the present disclosure can be made by stamping using a sheet metal process, and the corresponding technology is now very mature. The main reason for the use of the structure for the feed is: conventional metal micro-strip line need to have a medium as a substrate, so a dielectric substrate needs to be added to the section where the radiating patch is directly coupled and fed, as well as the upstream routing in front of it, in this case, the horizontal dielectric substrate needs to have a column of the appropriate size added at the corresponding position, and then the laser engraving routing process is used to design and process the feed network. Under this structure, mold opening and final antenna assembly are not the optimal methods. The embodiments of the present disclosure adopt the sheet metal process, which can directly process the required circuits as a whole without the need for additional structures to fix them in the suspended areas. The assembly is very simple, the cost is effectively reduced, and the performance can also be well guaranteed.

Specifically, voltage standing wave ratio (VSWR), coupling degree (S21), antenna gain and cross-polarization ratio (XPD) are important indicators of antenna performance.

Among them, the voltage standing wave ratio (VSWR) refers to the ratio of the standing wave belly voltage to the amplitude of the node voltage. If the ratio is 1, it means that the impedance of the feed network and antenna are perfectly matched and there is no reflection loss of energy. On the contrary, if the VSWR is infinity, it means total reflection and no energy is radiated at all. Therefore, the smaller the voltage VSWR is (the closer it is to 1), the fewer the port reflections and the better the match. For base station antennas, the most basic requirement is that the VSWR needs to be less than 1.5.

Here, the coupling degree (S21) refers to the forward transmission coefficient from port 1 (input port) to port 2 (coupled port). In an antenna, S21 represents the degree of coupling, or isolation (in absolute terms), between unit polarizations. In general, the base station antenna polarization isolation needs to be greater than 20 dB or 25 dB.

Among them, the ratio of the radiation power flux density of the antenna in a specified direction to the maximum radiation power flux density of the reference antenna (usually using an ideal point source) at the same input power; the antenna gain is used to measure the ability of an antenna to transmit and receive signals in a specific direction, and it is one of the important parameters for selecting a base station antenna. The higher the antenna gain is, the better the directionality is, the more concentrated the energy is, and the narrower the lobe is. For specific designs, it is generally required that the gain of small base stations (arrays) reach 12 dB or above, and some even require 16 dB or higher for higher directional requirements. Therefore, the higher the unit gain, the easier it is to achieve the design requirement of high gain with as few elements as possible in the array.

Among them, the cross polarization ratio refers to the difference between the power level of the antenna receiving with the same polarization (maximum receiving level) and the power level of receiving with different polarization (minimum receiving level) within the 3 dB beamwidth of the directional pattern, that is, the ratio of co-polarization to cross-polarization. The larger the cross-polarization ratio, the higher the polarization purity. The smaller the correlation between positive and negative 45° polarization, the generally required axial cross polarization ratio is greater than 18 dB.

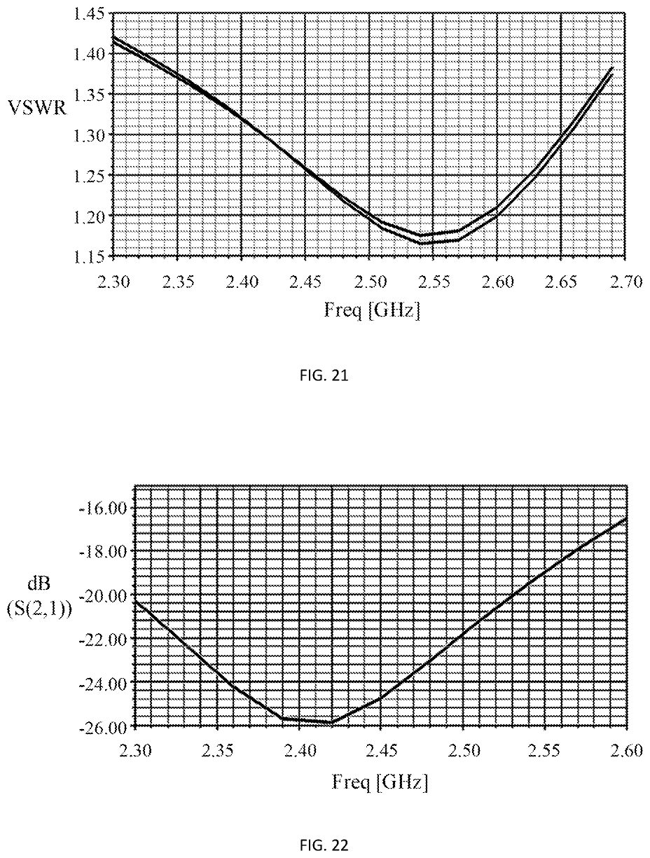

The inventor of the present disclosure simulates the antenna unit shown in FIG. 1 for voltage standing wave ratio (VSWR) and coupling degree (S21). As shown in FIG. 21 and FIG. 22, FIG. 21 shows a schematic diagram of the simulation results for VSWR, and FIG. 22 shows a schematic diagram of the simulation results for the coupling degree, which show that the antenna units provided by the present embodiments of the present disclosure have VSWRs of 1.42 or less, and the port coupling degree of −16 dB or less. Thus the antenna unit shown in FIG. 1 provided by embodiments of the present disclosure has good electrical performance.

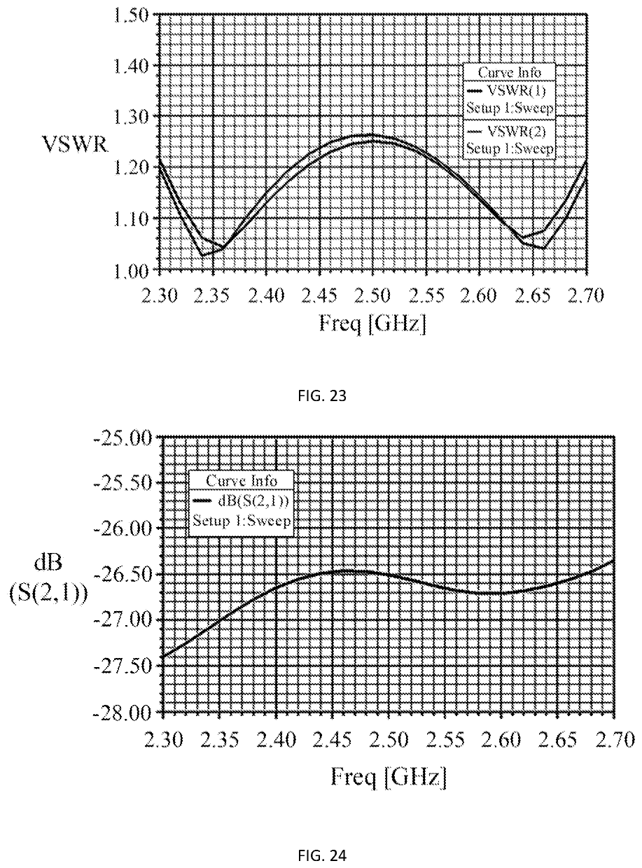

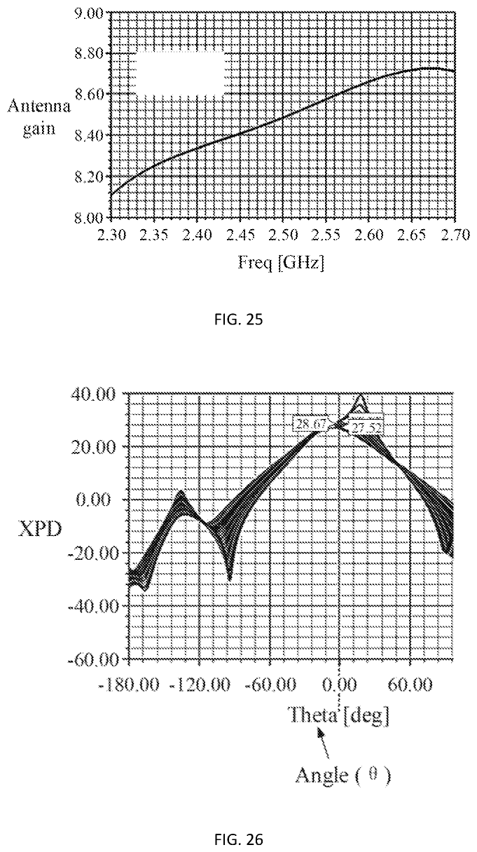

The inventor of the present disclosure conducts simulations of voltage standing wave ratio (VSWR), coupling degree (S21), antenna gain and cross-polarization ratio for the antenna unit shown in FIG. 4. As shown in FIGS. 23-26, FIG. 23 shows a schematic diagram of the simulation results of the VSWR, FIG. 24 shows a schematic diagram of the simulation results of the coupling degree, FIG. 25 shows a schematic diagram of the simulation results of the antenna gain, and FIG. 26 shows a schematic diagram of the simulation results of the cross-polarization ratio. It can be seen from the figures that the antenna units provided by the embodiments of the present disclosure all have an VSWR lower than 1.26 in the frequency band of 2.3-2.7 GHZ, which is able to satisfy the index requirements well; the isolation degree is greater than 26.3 dB, which is a better performance; the gain is higher than 8.1 dB, which is a better performance; and the axial cross-polarization ratio is greater than 27, which is a better performance. Therefore, the performance of the antenna unit provided by the embodiments of the present disclosure is all much better than the industry index requirements.

In summary, the embodiments of the present disclosure combine the feed network of the sheet metal process and the radiating patch and metal grounding plate of the highly transparent metal grid to realize a one-piece molded transparent antenna with lightweight, transparent beautification, and simple structure, which can be used in the mobile communication frequency band.

Based on the same inventive concept, the embodiments of the present disclosure also provide an antenna array including the above plurality of antenna units provided by the embodiments of the present disclosure.

The above antenna array provided by the embodiments of the present disclosure can realize the same effect as in one of the aforementioned antenna units, i.e., to provide a transparent antenna array that is lightweight, transparently beautified, and structurally simple, and can be used in a mobile communication frequency band.

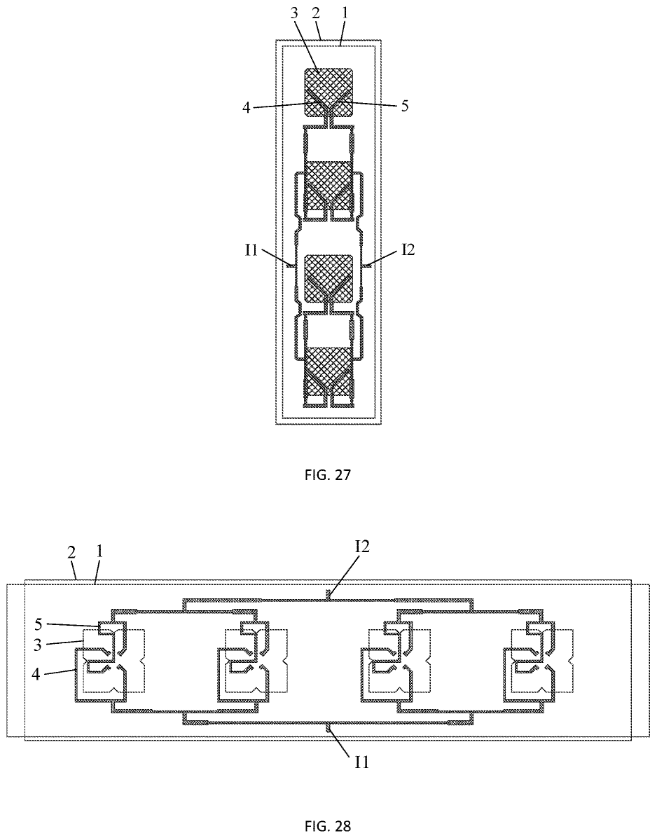

In specific implementations, in the above antenna array provided by the embodiments of the present disclosure, as shown in FIG. 27 and FIG. 28, FIG. 27 is a small base station antenna array formed by adopting the antenna unit shown in FIG. 1, and FIG. 28 is a small base station antenna array formed by adopting the antenna unit shown in FIG. 4, and the antenna units in FIG. 27 and FIG. 28 are in a 1×4 array, which is, of course, not limited to this, and the number of antenna units in the antenna array can be designed as desired. Here, an array of antenna units is used as a base station antenna, and can provide signals of different frequency bands, and the signal strength and coverage are better than that of a single antenna unit in general.

In specific implementations, the antenna units in the antenna array shown in FIG. 27 and FIG. 28 have the same structure as one of the aforementioned antenna units and will not be repeated.

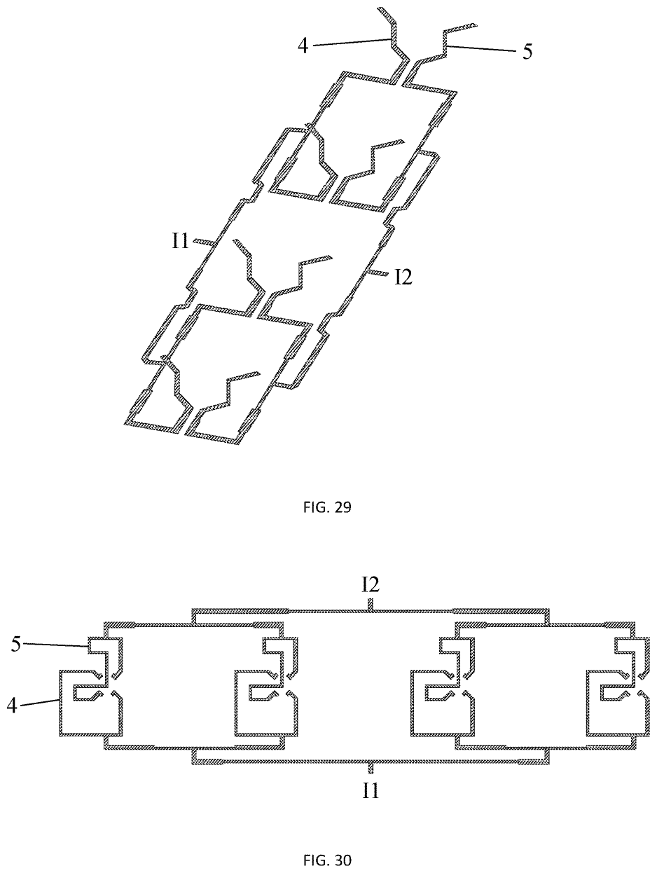

In specific implementations, in the above antenna array provided by embodiments of the present disclosure, as shown in FIG. 27 to FIG. 30, FIG. 29 shows a schematic diagram of the first feed network 4 and the second feed network 5 in FIG. 27, and FIG. 30 shows a schematic diagram of the first feed network 4 and the second feed network 5 in FIG. 28, and the first feed network 4 and the second feed network 5 of the plurality of antenna units are integrally molded using a sheet metal process. Specifically, each first feed network 4 is electrically connected to a first total input port 11, and each second feed network 5 is electrically connected to a second total input port 12.

The antenna unit provided by the embodiments of the present disclosure uses a metal grid film layer with high light transmittance in combination with a feed network integrally molded in sheet metal, which retains the antenna's transparent beautification characteristics while greatly reducing the cost and difficulty of assembly, and for antenna arrays, integrally molded sheet metal parts can be used to realize the function of power division feeding, and the structure is simple.

Based on the same inventive concept, embodiments of the present disclosure also provide a communication device including the above antenna array provided by embodiments of the present disclosure. The implementation of this communication device can be found in the above embodiments of the antenna unit, and the repetition will not be repeated.

Other essential components of the communication device are understood by those of ordinary skill in the art, and are not described herein, nor should they be taken as limitations of the present disclosure.

The embodiments of the present disclosure provide an antenna unit, an antenna array, and a communication device, by directly affixing the radiating patch to an inner side of the radome, so that there is no need to introduce a structure such as a fixed layer or a fixed snap to support the radiating patch, the antenna structure is simpler, and the overall profile height of the antenna can be effectively reduced in line with the existing antenna low-profile design concept. In addition, the feed network is integrally molded through the sheet metal process, and the required line can be directly and integrally processed and overhanging place does not need additional other structures to do fixed, assembly is more simple, not only strengthen the strength and consistency of the antenna, but also solved the problem of assembly cost and difficulty, which is more conducive to automated assembly and production of the antenna, and greatly reduces the antenna assembly of labor input.

Obviously, a person skilled in the art may make various alterations and variations to the present disclosure without departing from the spirit and scope of the present disclosure. Thus, if these modifications and variations of the present disclosure fall within the scope of the claims of the present disclosure and their technical equivalents, the present disclosure is intended to include such modifications and variations.

1. An antenna unit, comprising:
a substrate;
a radome, wherein the radome and the substrate form a cavity;
a radiating patch, wherein the radiating patch is provided within the cavity and is connected to a side of the radome facing the substrate;
at least one feed network, disposed within the cavity, wherein the feed network comprises: a planar transmission line on a side of the substrate facing the radome, a coupling end disposed close to a side of the radiating patch and having a set gap with the radiating patch, and a longitudinal connection line connecting the planar transmission line and the coupling end; wherein the planar transmission line, the longitudinal connection line and the coupling end of the feed network are integrally molded using a sheet metal process, and the feed network is used for coupling feed to the radiating patch;
a metal grounding plate, provided on a side of the substrate facing away from the radiating patch.

2. The antenna unit according to claim 1, wherein both the radiating patch and the metal grounding plate have a metal mesh-like structure.

3. The antenna unit according to claim 1, wherein the radiating patch is fixedly connected to the radome by means of an optical adhesive, and the metal grounding plate is fixedly connected to the substrate by means of the optical adhesive.

4. The antenna unit according to claim 1, wherein an orthographic projection of the radiating patch on the substrate covers orthographic projections of the coupling end and the longitudinal connection line on the substrate, as well as covers at least a part of an orthographic projection of the planar transmission line on the substrate.

5. The antenna unit according to claim 4, further comprising a first feed network and a second feed network disposed independently of each other,
wherein the first feed network comprises: a first planar transmission line on the side of the substrate facing the radome, a first coupling end disposed close to the side of the radiating patch and having a set gap with the radiating patch, and a first longitudinal connection line connecting the first planar transmission line and the first coupling end;
the second feed network comprises: a second planar transmission line on the side of the substrate facing the radome, a second coupling end disposed close to the side of the radiating patch and having a set gap with the radiating patch, and a second longitudinal connection line connecting the second planar transmission line and the second coupling end;
wherein the first planar transmission line, the first longitudinal connection line and the first coupling end form a micro-strip line and are integrally molded using the sheet metal process, and the second planar transmission line, the second longitudinal connection line and the second coupling end form a micro-strip line and are integrally molded using the sheet metal process.

6. The antenna unit according to claim 5, wherein orthogonal projections of the first planar transmission line, the first longitudinal connection line and the first coupling end on the substrate are located on a first straight line, and orthogonal projections of the second planar transmission line, the second longitudinal connection line and the second coupling end on the substrate are located on a second straight line, and the first straight line and the second straight line are provided orthogonally.

7. The antenna unit according to claim 6, wherein an orthographic projection of the first feed network on the substrate does not overlap an orthographic projection of the second feed network on the substrate, and a first end of the first planar transmission line away from the first longitudinal connection line is provided proximate to a second end of the second planar transmission line away from the second longitudinal connection line.

8. The antenna unit according to claim 7, wherein the first feed network further comprises a third planar transmission line on the substrate and connected to the first end, and the second feed network further comprises a fourth planar transmission line on the substrate and connected to the second end; wherein
the third planar transmission line is connected to the first planar transmission line at an angle greater than or equal to 90° and less than or equal to 135°, and the fourth planar transmission line is connected to the second planar transmission line at an angle greater than or equal to 90° and less than or equal to 135°;
wherein the first feed network and the second feed network are mirror symmetrical about a center of the radiating patch.

9. (canceled)

10. The antenna unit according to claim 6, wherein an orthographic projection of the first coupling end on the substrate overlaps with an orthographic projection of the second coupling end on the substrate, the first coupling end is provided below the second coupling end, the first coupling end is bent at the overlap towards a side close to the substrate, and the second coupling end is bent at the overlap towards a side away from the substrate.

11. The antenna unit according to claim 5,
wherein a sum of lengths of the first planar transmission line, the first longitudinal connection line, and the first coupling end is a quarter wavelength of an operating frequency of the antenna unit, and a sum of lengths of the second planar transmission line, the second longitudinal connection line, and the second coupling end is a quarter wavelength of the operating frequency of the antenna unit.

12. The antenna unit according to claim 4, further comprising a first feed network and a second feed network disposed independently of each other;
wherein the first feed network comprises: a first input port on the side of the substrate facing the radome, a fifth planar transmission line and a sixth planar transmission line provided on the side of the substrate facing the radome and connected to the first input port, a first differential coupling end and a second differential coupling end provided close to a side of the radiating patch and having a set gap with the radiating patch, a third longitudinal connection line connecting the fifth planar transmission line and the first differential coupling end, and a fourth longitudinal connection line connecting the sixth planar transmission line and the second differential coupling end;
the second feed network comprises: a second input port on the side of the substrate facing the radome, a seventh planar transmission line and an eighth planar transmission line provided on the side of the substrate facing the radome and connected to the second input port, a third differential coupling end and a fourth differential coupling end provided close to the side of the radiating patch and having a set gap with the radiating patch, a fifth longitudinal connection line connecting the seventh planar transmission line and the third differential coupling end, and a sixth longitudinal connection line connecting the eighth planar transmission line and the fourth differential coupling end;
wherein the first input port, the fifth planar transmission line, the sixth planar transmission line, the third longitudinal connection line, the fourth longitudinal connection line, the first differential coupling end and the second differential coupling end form a differential structure and are integrally molded by the sheet metal process, and the second input port, the seventh planar transmission line, the eighth planar transmission line, and the fifth longitudinal connection line, the sixth longitudinal connection line, the third differential coupling end and the fourth differential coupling end form a differential structure and are integrally molded using the sheet metal process.

13. The antenna unit according to claim 11, wherein the first input port and the second input port are opposite to each other, and a connecting line of the first differential coupling end and the second differential coupling end is provided orthogonally to a connecting line of the third differential coupling end and the fourth differential coupling end;
the radiating patch is divided into four regions along a symmetry axis of the radiating patch, and the first differential coupling end, the second differential coupling end, the third differential coupling end and the fourth differential coupling end are provided in one-to-one correspondence with the regions;
wherein a difference between a length of the fifth planar transmission line and a length of the sixth planar transmission line is one-half the wavelength of the operating frequency of the antenna unit, and a difference between a length of the seventh planar transmission line and a length of the eighth planar transmission line is one-half the wavelength of the operating frequency of the antenna unit.

14. (canceled)

15. The antenna unit according to claim 13, wherein the fifth planar transmission line, the sixth planar transmission line, the seventh planar transmission line and the eighth planar transmission line each are folded lines;
wherein an orthographic projection of the first feed network on the substrate does not overlap an orthographic projection of the second feed network on the substrate;
the fifth planar transmission line and the sixth planar transmission line form a semi-enclosed structure, a portion of the seventh planar transmission line extends into the semi-enclosed structure through a notch in the semi-enclosed structure, and the eighth planar transmission line is located outside of the semi-enclosed structure.

16.-17. (canceled)

18. The antenna unit according to claim 15, wherein shapes of the first differential coupling end, the second differential coupling end, the third differential coupling end and the fourth differential coupling end comprise an “L” shape,
one ends of long sides of the “L” shapes away from short sides are connected to the third longitudinal connection line, the fourth longitudinal connection line, the fifth longitudinal connection line, and the sixth longitudinal connection line, respectively, in one-to-one correspondence, and the short sides of the “L” shapes are disposed close to a center of the radiating patch.

19. The antenna unit according to claim 18,
wherein the long side and the short side in the “L” shape are provided parallel to the radiating patch; or,
wherein the long side in the “L” shape is provided in parallel to the radiating patch, and the short side in the “L” shape is bent along one end of the long side away from the radiating patch.

20. The antenna unit according to claim 19, wherein the long side of the “L” shape at the first differential coupling end and the long side of the “L” shape at the second differential coupling end are disposed in a third straight line,
the long side of the “L” shape at the third differential coupling end and the long side of the “L” shape at the fourth differential coupling end are disposed in a fourth straight line,
the third straight line and the fourth straight line are provided orthogonal;
wherein the first differential coupling end, the second differential coupling end, the third differential coupling end, and the fourth differential coupling end are mirror symmetrical about a center of the radiating patch.

21. (canceled)

22. The antenna unit according to claim 1, wherein a ratio of a size of the radiating patch to a wavelength of an operating frequency of the antenna unit is 0.44 to 0.48;
wherein a shape of the radiating patch comprises a square, a tangent square, a circle or a tangent polygon;
wherein a shape of the radiating patch comprises four circles or rhombuses integrally formed and centrally symmetrical;
or, a shape of the radiating patch comprises four hexagonal shapes independently disposed and centrally symmetrical;
wherein a material of the substrate comprises PC, COP, PET, PMMA or glass, and a material of the radome comprises PC, COP, PET or PMMA.

23.-25. (canceled)

26. An antenna array, comprising a plurality of antenna units,
wherein the antenna unit comprises:
a substrate;
a radome, wherein the radome and the substrate form a cavity;
a radiating patch, wherein the radiating patch is provided within the cavity and is connected to a side of the radome facing the substrate;
at least one feed network, disposed within the cavity, wherein the feed network comprises: a planar transmission line on a side of the substrate facing the radome, a coupling end disposed close to a side of the radiating patch and having a set gap with the radiating patch, and a longitudinal connection line connecting the planar transmission line and the coupling end; wherein the planar transmission line, the longitudinal connection line and the coupling end of the feed network are integrally molded using a sheet metal process, and the feed network is used for coupling feed to the radiating patch;
a metal grounding plate, provided on a side of the substrate facing away from the radiating patch.

27. The antenna array according to claim 26, wherein feed networks of the plurality of the antenna units are integrally molded using the sheet metal process.

28. A communication device, comprising an antenna array comprising a plurality of antenna units, wherein the antenna unit comprises:
a substrate;
a radome, wherein the radome and the substrate form a cavity;
a radiating patch, wherein the radiating patch is provided within the cavity and is connected to a side of the radome facing the substrate;
at least one feed network, disposed within the cavity, wherein the feed network comprises: a planar transmission line on a side of the substrate facing the radome, a coupling end disposed close to a side of the radiating patch and having a set gap with the radiating patch, and a longitudinal connection line connecting the planar transmission line and the coupling end; wherein the planar transmission line, the longitudinal connection line and the coupling end of the feed network are integrally molded using a sheet metal process, and the feed network is used for coupling feed to the radiating patch;
a metal grounding plate, provided on a side of the substrate facing away from the radiating patch.
